(19) United States
(12) Patent Application Publication
(10) Pub. No.: US 2007/0221030 A1
(43) Pub. Date: Sep. 27, 2007

(54) Punching device for oval edge decoration

(76) Inventor: Wan-Young Oh, Seoul (KR)

Correspondence Address: JONES DAY, 222 EAST 41ST ST, NEW YORK, NY, 10017, US

(21) Appl. No.: 11/455,255

(22) Filed: Jun. 16, 2006

(30) Foreign Application Priority Data
Mar. 27, 2006 (KR) 20-2006-008124

(51) Int. Cl. B26F 1/14

(52) U.S. Cl. 83/684

(57) ABSTRACT

A punching device for punching an edge of an oval subject to make a pattern includes a jig having a pattern hole with a predetermined pattern and supplied with the subject to be patterned; a punching member having a punch pin corresponding to the pattern hole so as to form a punching pattern by punching an edge of the subject supplied to the jig; and a base on which the jig and the punching member are coupled, the base giving a base surface on which the subject to be punched is supplied, wherein the base includes: a rotation guide projection for guiding an edge of the oval subject with the same curvature as the edge when the subject is rotating; a positioning guide projection for setting an initial position of the subject together with at least a part of the rotation guide projection so that an initial punching region of the oval subject is punched; and a criterion marking having the same pattern as the pattern of the pattern hole of formed as a part of the pattern so as to set a rotating angle of the oval subject so that the punching pattern is successively formed.

### BACKGROUND OF THE INVENTION

1. Field of the Invention

The present invention relates to a punching device for oval edge decoration, and more particularly to a punching device capable of successively punching a pattern along an edge of an oval subject to make an oval pattern material.

2. Description of the Related Art

Generally, a punching device is called ‘punch’ and it includes a jig having a pattern hole of a predetermined pattern, and a sharp cutting means for sliding in the pattern hole so that a subject is perforated according to a shape of the pattern hole.

Now, various punching devices are introduced in various structures, but they are just directed to cutting off a specific portion of the subject and not suitable for exactly punching the subject along its edge. Furthermore, these punching devices are limited just to punching an edge of a subject only having a typical shape such as circle or rectangle.

### SUMMARY OF THE INVENTION

The present invention is designed to solve the problems of the prior art, and therefore it is an object of the present invention to provide a punching device for oval edge decoration, which is capable of forming a pattern by successively punching an edge of a subject having an oval or rugby-ball shape.

In order to accomplish the above object, the present invention provides a punching device for punching an edge of an oval subject to make a pattern, which includes a jig having a pattern hole with a predetermined pattern and supplied with the subject to be patterned; a punching member having a punch pin corresponding to the pattern hole so as to form a punching pattern by punching an edge of the subject supplied to the jig; and a base of which the jig and the punching member are coupled, the base giving a base surface on which the subject to be punched is supplied, wherein the base includes: a rotation guide projection for guiding an edge of the oval subject with the same curvature as the edge when the subject is rotating; a positioning guide projection for setting an initial position of the subject together with at least a part of the rotation guide projection so that an initial punching region of the oval subject is punched; and a criterion marking having the same pattern as the pattern of the pattern hole or formed as a part of the pattern so as to set a rotating angle of the oval subject so that the punching pattern is successively formed.

Preferably, based on a major axis of the oval subject, an edge at one side of the oval subject is contacted with at least a part of the rotation guide projection, and an edge at the other side of the oval subject is contacted with the positioning guide projection, thereby setting the initial position.

More preferably, the number n (n is an integer) of punching patterns are formed in any one-side edge of the oval subject on the basis of a major axis of the oval subject.

Here, at least a part of the guide projection may be protruded from the base.

In another aspect of the present invention, there is also provided a punching device for respectively punching edges of a first oval subject and a second oval subject having different sizes to form a pattern, which includes a jig having a pattern hole with a predetermined pattern and supplied with the subject; a punching member having a punch pin corresponding to the pattern hole so as to form a punching pattern by punching an edge of the subject supplied to the jig; and a base on which the jig and the punching member are coupled, the base giving a base surface on which the subject is supplied, wherein the base includes a first rotation guide projection for guiding an edge of the first oval subject with the same curvature as the edge when the first oval subject is rotating; a first positioning guide projection for setting an initial position of the first oval subject together with at least a part of the first rotation guide projection so that an initial punching region of the first oval subject is punched; a first criterion marking having the same pattern as the pattern of the pattern hole or formed as a part of the pattern so as to set a rotating angle of the first oval subject so that the punching pattern is successively formed; a second rotation guide projection for guiding an edge of the second oval subject with the same curvature as the edge when the second oval subject is rotating; a second positioning guide projection for setting an initial position of the second oval subject together with at least a part of the second rotation guide projection so that an initial punching region of the second oval subject is punched; and a second criterion marking having the same pattern as the pattern of the pattern hole or formed as a part of the pattern so as to set a rotating angle of the second oval subject so that the punching pattern is successively formed.

Preferably, based on a major axis of the first oval subject, an edge at one side of the first oval subject is contacted with at least a part of the first rotation guide projection, and an edge at the other side of the first oval subject is contacted with the first positioning guide projection, and, based on a major axis of the second oval subject, an edge at one side of the second oval subject is contacted with at least a part of the second guide projection, and an edge at the other side of the second oval subject is contacted with the second positioning guide projection, thereby setting the initial positions respectively.

Preferably, the first positioning guide projection and the first criterion marking are respectively formed at an opposite side to the second positioning guide projection and the second criterion marking, and the first oval subject and the second oval subject are rotated in opposite directions during successive punching.

### BRIEF DESCRIPTION OF THE DRAWINGS

Other objects and aspects of the present invention will become apparent from the following description of embodiments with reference to the accompanying drawing in which:

FIG. 1 is an exploded perspective view showing a punching device for oval edge decoration according to a preferred embodiment of the present invention;

FIG. 2 is an exploded perspective view showing the punching device for oval edge decoration according to the preferred embodiment of the present invention;

FIG. 3 is a plain view schematically showing a base and a punching member of the punching device for oval edge decoration according to the preferred embodiment of the present invention;

FIGS. 4a and 4b are plain views showing an oval subject to be punched, which is used in the punching device according to the preferred embodiment of the present invention;

FIG. 5 is a perspective view illustrating the process of making the subject of FIGS. 4a or 4b using a cutting member;

FIGS. 6a to 6c are perspective views subsequently illustrating the process of punching an edge of the oval subject of FIG. 4a using the punching device according to the preferred embodiment of the present invention;

FIGS. 7a to 7c are plain views schematically showing the base and the subject in order to illustrate the process of punching an edge of the oval subject of FIG. 4a using the punching device according to the preferred embodiment of the present invention;

FIG. 8 is a plain view showing an oval pattern material made by the punching work of FIGS. 6a to 6c or FIGS. 7a to 7c;

FIGS. 9a to 9c are perspective views subsequently illustrating the process of punching an edge of the oval subject of FIG. 4b using the punching device according to the preferred embodiment of the present invention;

FIGS. 10a to 10c are plain views schematically showing the base and the subject in order to illustrate the process of punching an edge of the oval subject of FIG. 4b using the punching device according to the preferred embodiment of the present invention; and

FIG. 11 is a plain view showing an oval pattern material made by the punching work of FIGS. 9a to 9c or FIGS. 10a to 10c.

### DESCRIPTION OF THE PREFERRED EMBODIMENT

Hereinafter, the present invention will be described in more detail referring to the drawings.

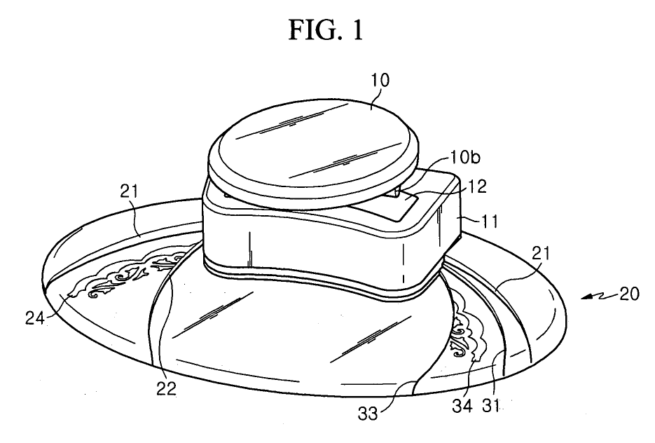

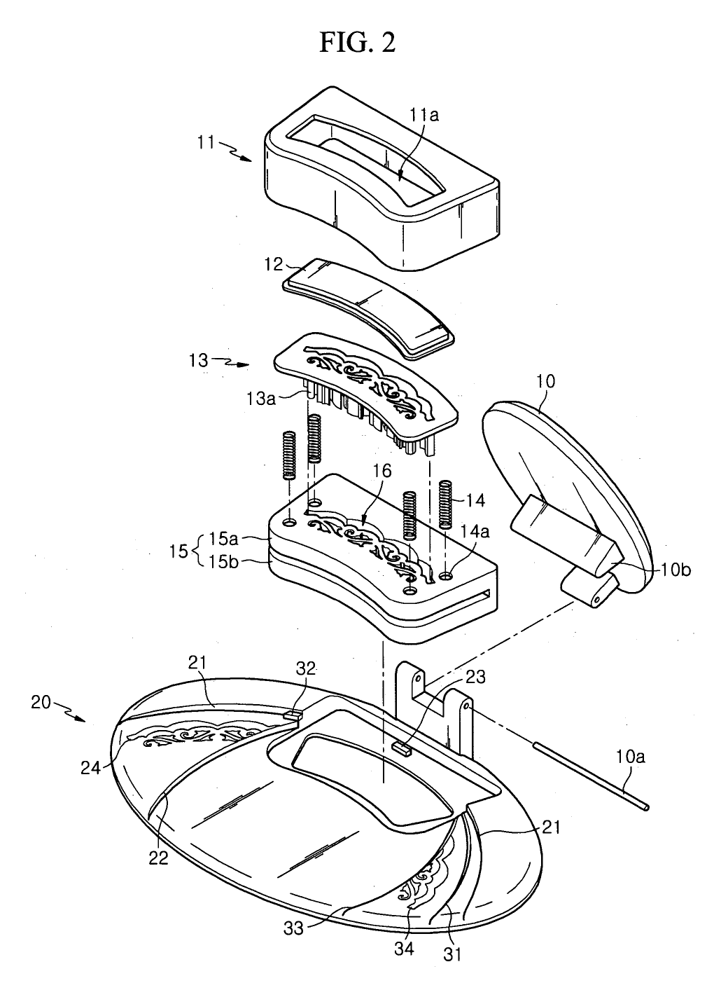

FIG. 1 is a perspective view showing a punching device for edge decoration according to a preferred embodiment of the present invention, and FIG. 2 is an exploded perspective view of the punching device.

Referring to FIGS. 1 and 2, the punching device includes a push lever 10, a punching member 13 pressed by the push lever 10, a jig 15 for guiding movement of the punching member 13, and a base 20 on which a subject to be punched is placed.

The push lever 10 is pivotally connected to the base 20 and presses the punching member 13 downward when a user pushes it down.

The punching member 13 used for perforating a supplied subject to form a pattern has a punch pin 13a formed in its lower portion in correspondence to a desired punching pattern. At a lower end of the punch pin 13a, a sharp cutting blade is formed so as to perforate a subject easily and cleanly.

The jig 15 supports the supplied subject for perforation. The jig 15 includes upper and lower plates 15a, 15b facing each other in parallel and forming a space between them so that a subject to be punched is inserted between the plates 15a, 15b.

The lower plate 15b has a pattern hole corresponding to the punch pin 13a, and the upper plate 15a has a guide hole 16 for guiding vertical movement of the punch pin 13a.

An elastic member 14 is interposed between the punching member 13 and the jig 15 so as to elastically bias the punching member 13 upward toward the jig 15. If the punching member 13 moves down to punch a subject supplied to the jig 15, the punching member 13 is then returned to its original position due to the elasticity of the elastic member 14.

For this purpose, one end of the elastic member 14 is coupled to a support 14a formed on one side of the upper plate 15a, and the other end is coupled to the punching member 13, thereby providing elasticity to the punching member 13. Preferably, the elastic member 14 is a spring. The elastic member 14 may also use various kinds of elastic members such as a leaf spring.

Though it is illustrated that the support 14a has a groove shape so that a lower end of the elastic member 14 is seated thereon, the support may also be prepared to have a protrusive shape so that the support may be inserted into a lower end of the elastic member 14, but not limitedly.

Preferably, the punching member 13 and the jig 15 are stably coupled in a housing 11. A through hole 11a is formed in an upper surface of the housing 11 so that push pin 10b of the push lever 10 may press an upper surface of the punching member 13 through the through hole 11a.

More preferably, a cap member 12 may be further mounted between the push lever 10 and the punching member 13 so that the push lever 10 and the punching member 13 may operate more easily without directly contacting with each other. The cap member 12 distributes a pressing force of the push lever 10 over the upper surface of the punching member 13 though the push pin 10b is contacted with a small area of the cap member 12.

The base 20 forms a basis of the device and gives a base surface for supporting the above components and supplied with a subject to be punched. The push lever 10 is pivotally hinged to the base 20.

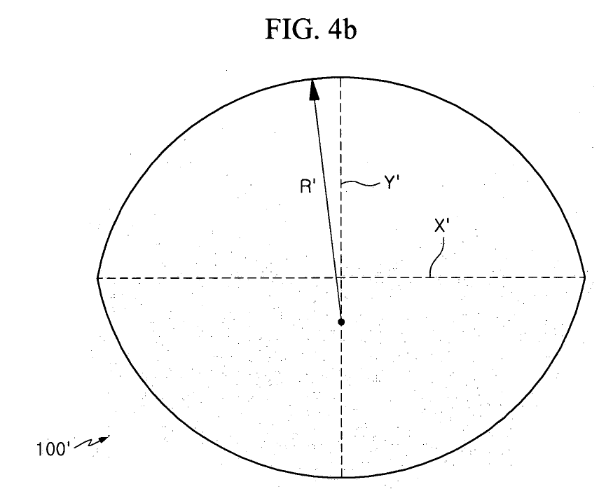

The punching device of the present invention, for example, successively punches an edge of an oval subject 100, 100′, as shown in FIGS. 4a and 4b, to form a pattern. In the specification and claims, the term ‘oval’ is defined to include not only an oval shape in terms of mathematics but also a rugby-ball shape having a major axis X and a minor axis Y with different lengths as shown in FIG. 4a.

In addition, the punching device of the present invention can punch edges of oval subjects with different “sizes”. In the specification and claims, the term ‘oval shape with different sizes’ is defined as shapes with different curvatures or different ratios of a major axis to a minor axis. For example, the first oval 100 and the second oval 100′ as shown in FIGS. 4a and 4b have different ratios of major axes X, X′ to minor axes Y, Y′, and different curvatures R, R′.
X/Y>X′/Y′ Equation 1
R>R′ Equation 2

Here, as the X/Y value is greater, the oval is slimmer, and as the value is smaller, the oval is fatter.

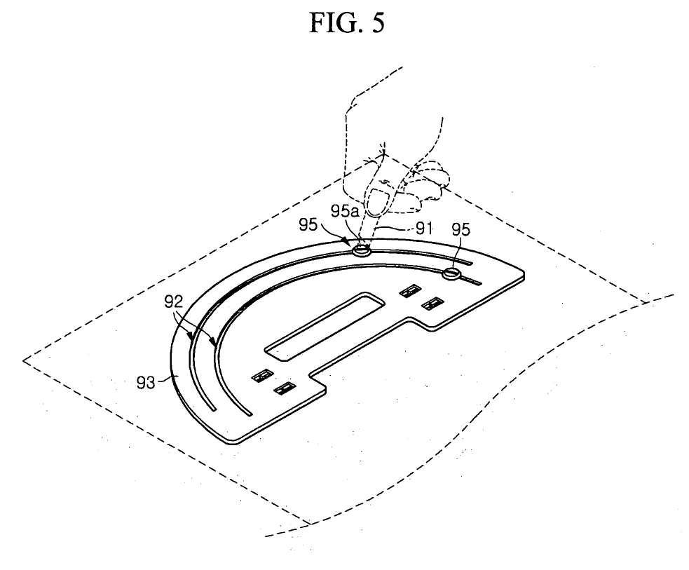

The oval subject 100, 100′ as mentioned above can be prepared using a cutting means shown in FIG. 5, as an example. The cutting means includes a frame 93 having a cutting slot 92 with a predetermined curvature, and a cutting guide 95 installed to the cutting slot 92. The cutting slot 92 has the same curvature as a desired oval subject 100, 100′.

With the cutting means being placed on a paper as an example, a blade 91 is inserted into a groove 95a of the cutting guide 95 and moved along the cutting slot 92 to cut the paper, and then a one-side edge of the oval subject 100, 100′ is obtained. And then, the cutting means is turned over to an opposite side and then cuts the paper in the same way, thereby making a perfect oval subject 100, 100′. Here, the cutting guide 95 prevents the frame 93 from being damaged due to the blade 91.

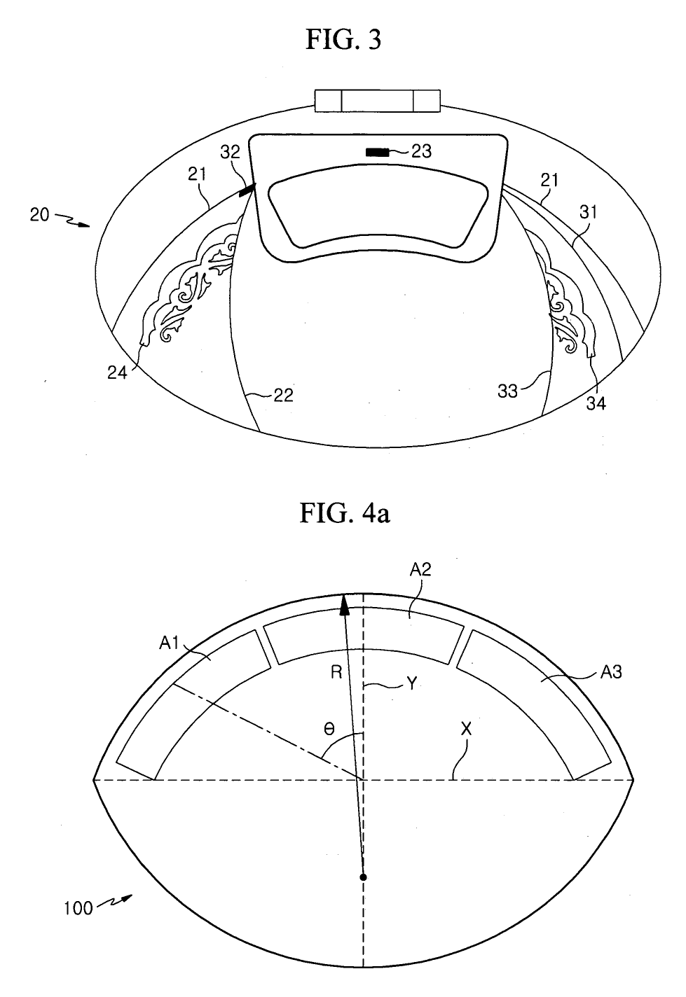

The base 20 employed in the present invention has a special configuration in order to punch an edge of the above oval subject 100, 100′, as described below in detail with reference to FIG. 3 that schematically shows the configuration of the base 20.

The base 20 includes a rotation guide projection 21 for guiding a rotating trajectory of the oval subject 100, and a positioning guide projection 22 for setting an initial position of the subject 100.

The rotation guide projection 21 has the same curvature as the edge of the subject 100. Preferably, as shown in FIG. 3, the rotation guide projection 21 is respectively formed on both sides of the jig 15 where the punching work is conducted.

The positioning guide projection 22 sets a position at which the oval subject 100 is initially placed, and also has the same curvature as the edge of the subject 100. The positioning guide projection 22 sets an initial position of the subject 100 together with a part of the rotation guide projection 21, for example together with a right part of the rotation guide projection 21 in this embodiment.

According to the present invention, the oval subject 100 as shown in FIG. 4a is firstly punched in its one-side (right) edge based on the major axis X, and then punched in the other side (left) edge. In addition, the one-side edge of the oval subject 100 is punched several times subsequently in punching regions A1, A2, A3 to form a pattern. One punching region corresponds to a region where a pattern is formed by one-time punching behavior. Preferably, a length of the one-side edge of the subject 100 is set so that a successive and perfect pattern is made by means of the n-time (e.g. three times in this embodiment) punching. Thus, the term ‘initial positioning’ of the oval subject used in the specification and claims is defined that a subject is arranged on the base 20 so that an initial punching region A1 can be initially punched when a one-side edge of the subject is punched.

Preferably, an auxiliary guide projection 23 for additionally guiding the oval subject may be further formed on the base 20. The auxiliary guide projection 23 is integrally formed on the base 20, and guides a subject between the upper plate 15a and the second plate 15b through the lower plate 15b of the jig 15.

In addition, a criterion marking 24 is established on the base 20 so as to set a rotating angle when an oval subject is punched. The criterion marking 24 has the same pattern as the section of the punch pin 13a or is formed as a part of the pattern, and it gives a criterion for rotating a subject 100, 100′ so that the punching pattern 28 may be successively punched.

Specifically, after the first punching region A1 of the subject 100 shown in FIG. 4a is punched, the subject 100 is rotated in a counterclockwise direction so that the second punching region A2 is placed on the jig 15, and then the criterion marking 24 is formed at a point where the pattern of the first punching region A1 is exactly coincided with the criterion marking 24. Thus, if the subject is punched after the subject is rotated so that the punching pattern is coincided with the criterion marking, the punching pattern can be successively formed, as described later.

Now, the operation for punching an edge of a subject 100 using the punching device according to the preferred embodiment of the present invention will be described.

First, a subject 100 to be punched is obtained using the cutting means shown in FIG. 5 as described above.

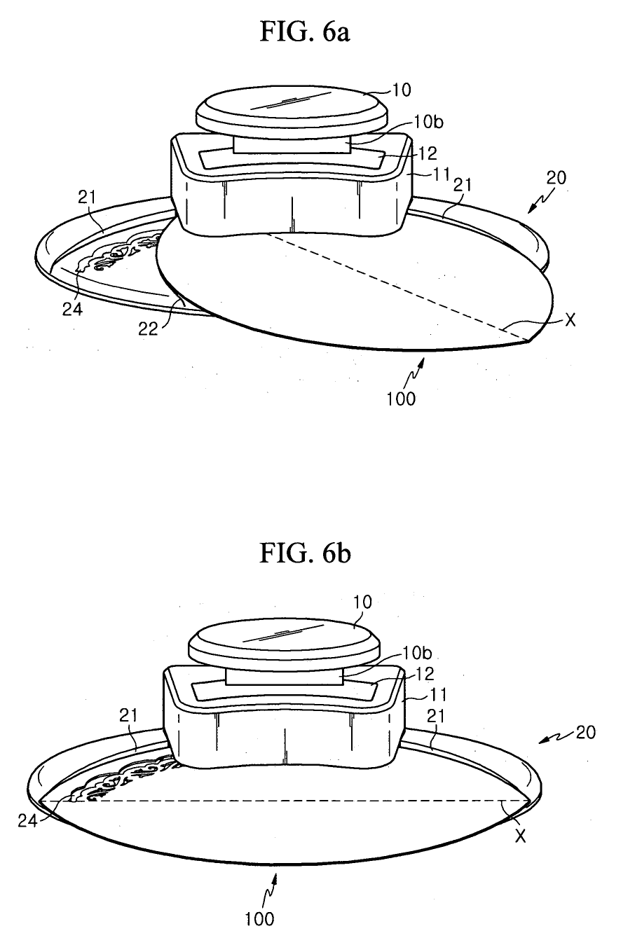

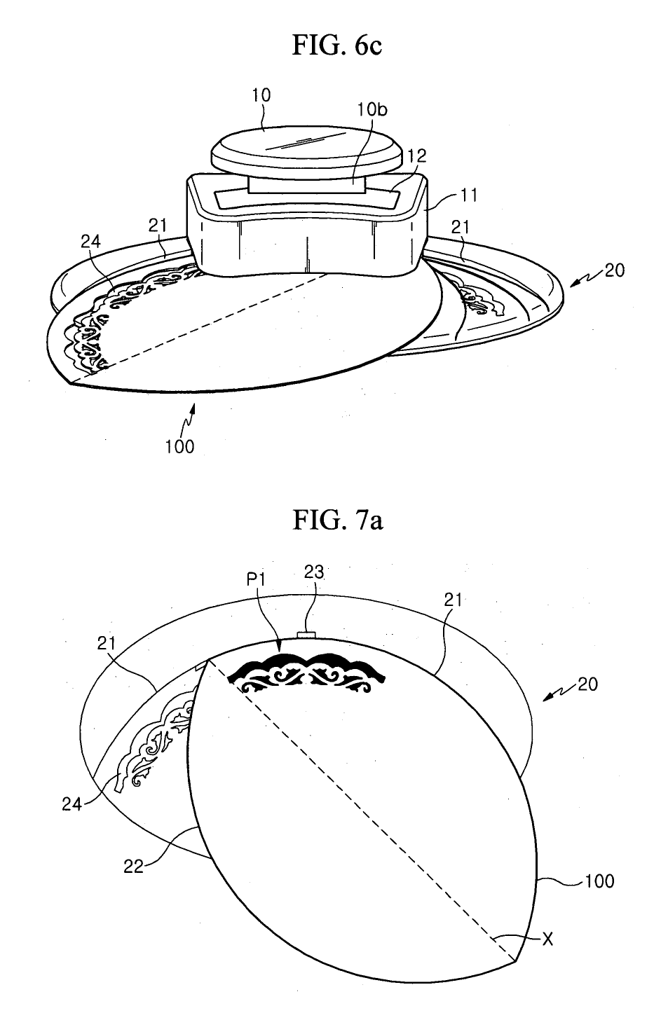

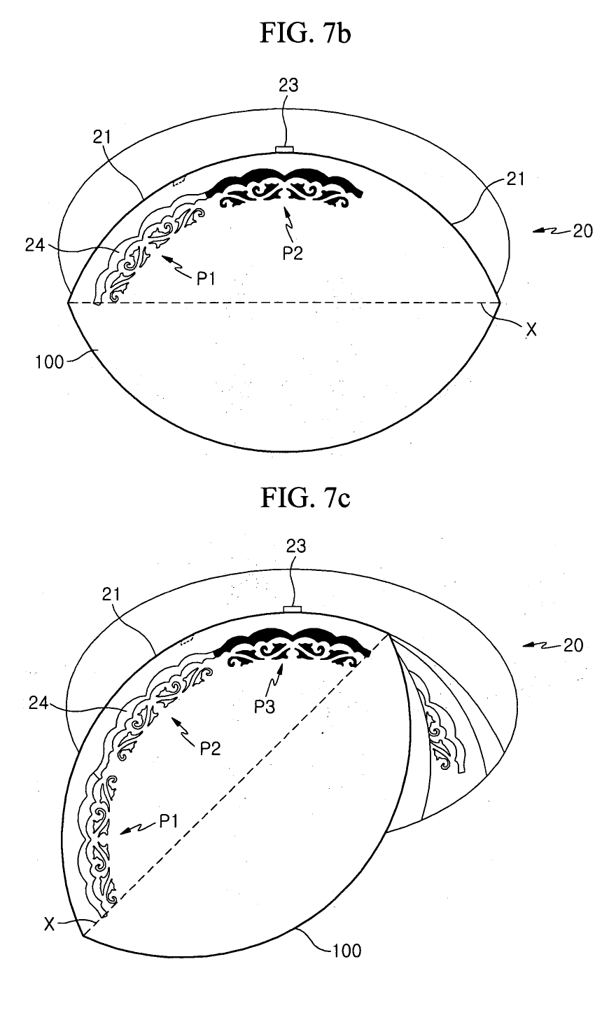

The subject 100 is punched in each of right and left edges based on the major axis X. In order to punch an initial punching region A1 in the right edge of the subject 100, as shown in FIGS. 6a and 7a, the subject 100 is set to an initial position. The initial positioning may be conducted in a way that the subject 100 is arranged between the rotation guide projection 21 and the positioning guide projection 22. That is to say, the right edge of the subject 100 is contacted with a part of the rotation guide projection 21, and the left edge is contacted with the positioning guide projection 22 for the purpose of arrangement. While the subject 100 is set to the initial position as mentioned above, the initial punching region A1 is placed at a position where it can be punched by the punching member 13. In this state, the push lever 10 is pressed to punch the subject by means of the punching member 13, thereby forming a first punching pattern P1 (shown as a black area).

Subsequently, the subject 100 is rotated in a counterclockwise direction for the next punching. At this time, the edge of the subject 100 is guided by the rotation guide projection 21. The subject 100 is rotated to a position where the first punching pattern P1 already formed is coincided with the criterion marking 24 expressed on the base 20, thereby coming to the state shown in FIGS. 6b and 7b. That is to say, the criterion marking 24 sets an angle θ (see FIG. 4a) at which the subject 100 is rotated, and in this state the second punching region A2 is positioned below the punching member 13.

If the subject 100 is punched in this state, a second punching pattern P2 is successively punched after the first punching pattern P1.

The subject 100 is rotated as much as the angle θ in a counterclockwise direction to come to the state of FIGS. 6c and 7c so that the second punching pattern P2 is coincided with the criterion marking 24, and then the subject 100 is punched to form a third punching pattern P3 in the same way as above.

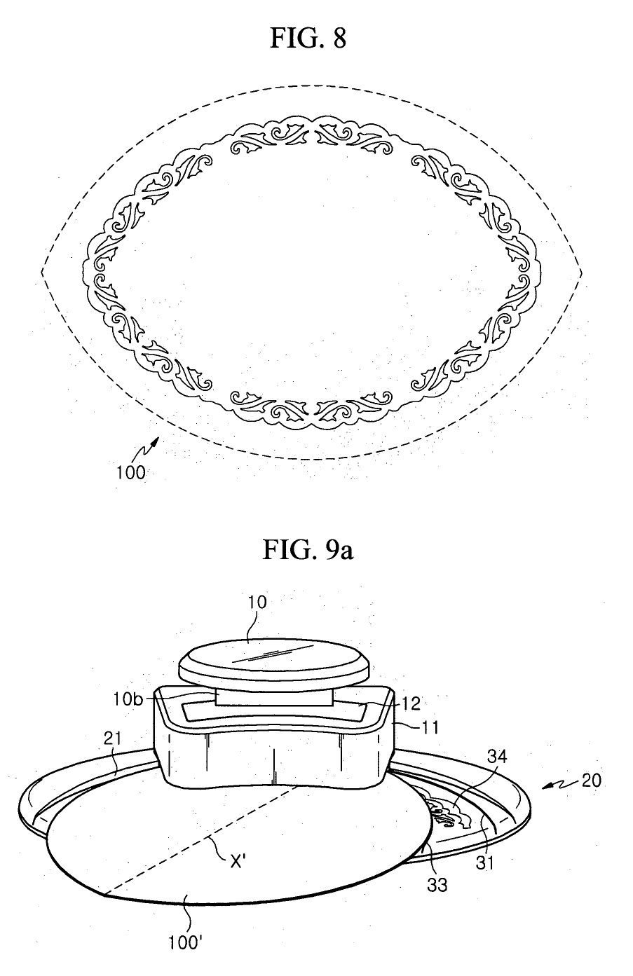

Preferably, after the integer number of punching patterns are formed in the one-side (right) edge of the subject based on the major axis X, the other side (left) edge is punched in the same way as above, and then an oval pattern material as shown in FIG. 8 can be made.

The punching device of the present invention is configured to be capable of punching an edge of an oval subject 100′ (see FIG. 4b) having different ratios of major axis to minor axis or different curvatures. For this purpose, second rotation guide projections 31, 32 having the same curvature as a second subject 100′ to be punched are formed on the base 20. According to this embodiment, the second rotation guide projections 31, 32 have smaller curvature than the first rotation guide projection 21. The second rotation guide projections 31, 32 are also provided to both sides based on the punching member 13, and a part of the second rotation guide projection is protruded as indicated by the reference numeral 32 for the convenience of designing and manufacturing. However, the present invention is not limited thereto, but all of the second rotation guide projections can be formed as a continuous projection.

In addition, a second positioning guide projection 33 is formed on the base 20 so as to set an initial position of the second object 100′. Preferably, the second subject 100′ is punched with rotating in a direction opposite to the first subject 100, for example in a clockwise direction, so the second positioning guide projection 33 is also positioned on an opposite side to the first positioning guide projection 22. Accordingly, a second criterion marking 34 for setting a rotating angle of the second subject 100′ is also preferably formed on the base 20 opposite to the first criterion marking 24.

The second rotation guide projections 31, 32 and the second positioning guide project 33 are suitably formed not to disturb positioning and rotation of the first subject 100.

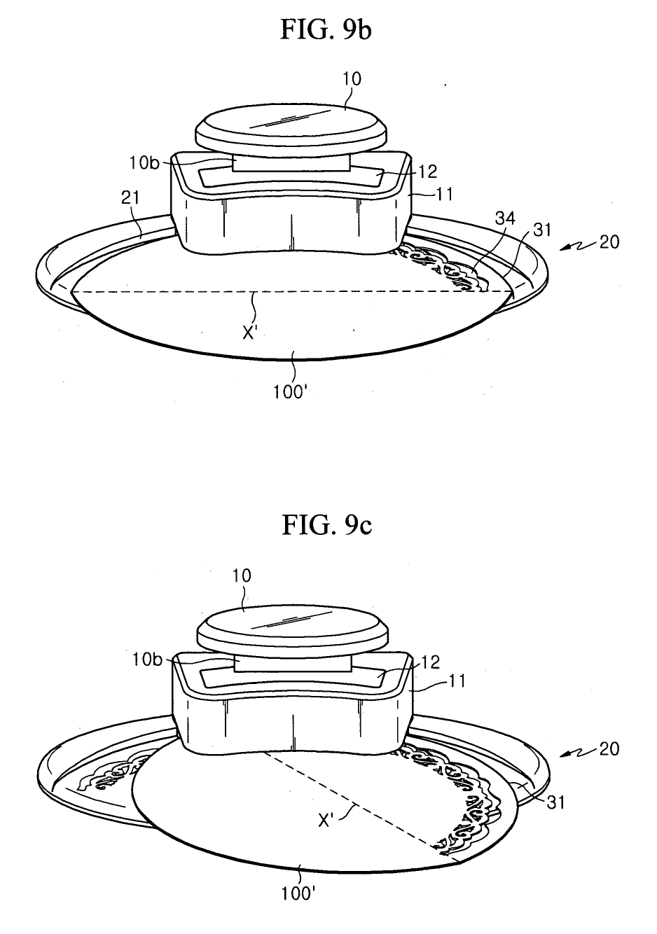

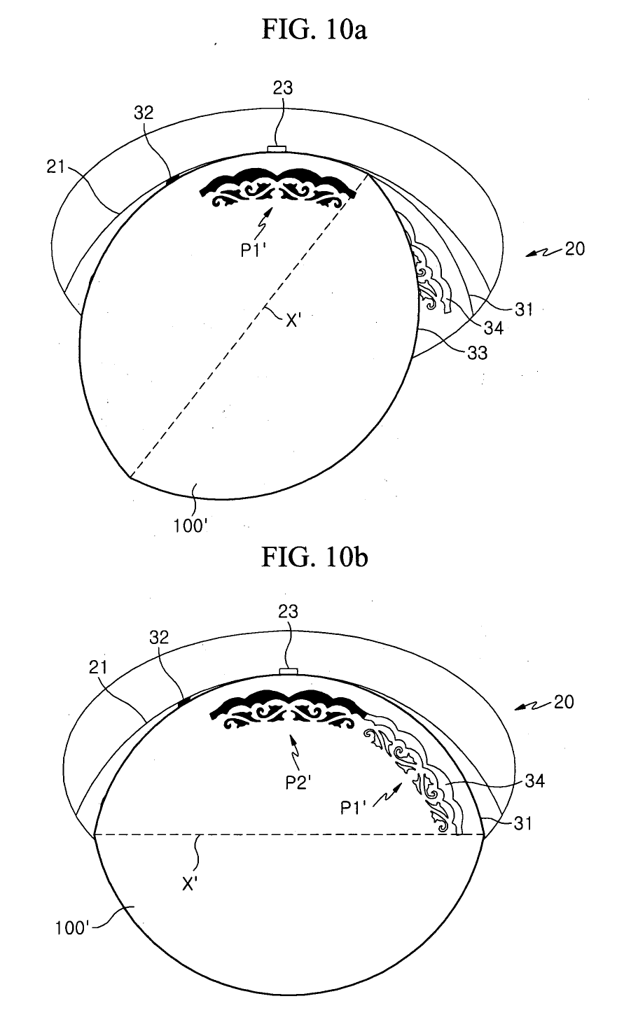

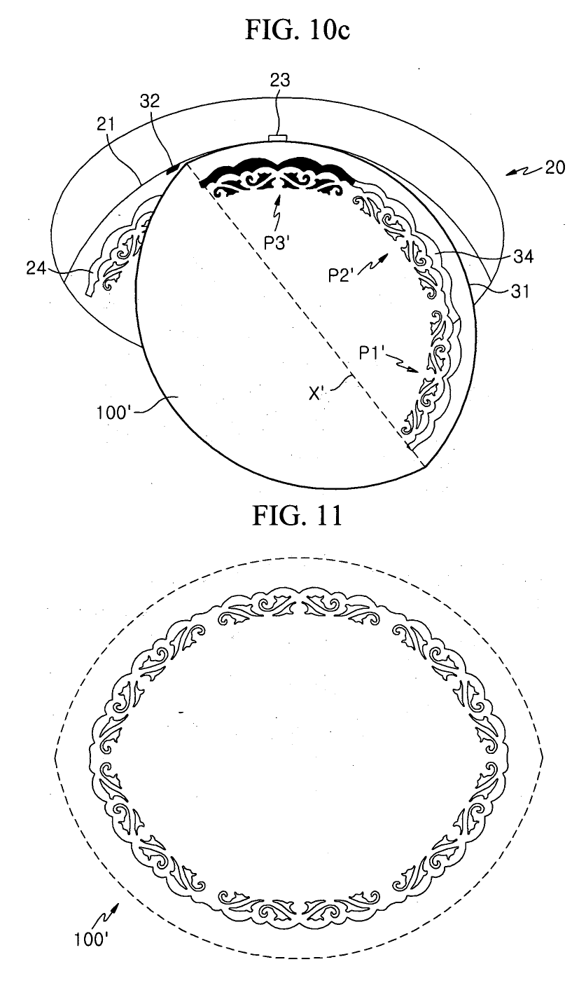

The process of punching an edge of the second subject 100′ is subsequently illustrated in FIGS. 9a to 9c and FIGS. 10a to 10c.

The second subject 100′ is punched separately in each of the right and left edges based on the major axis X′. In order to punch an initial punching region (corresponding to A1 of FIG. 4a) in the left edge of the second subject 100′, as shown in FIGS. 9a and 10a, the subject 100′ is set to an initial position. The initial positioning may be conducted in a way of arranging the second subject 100′ between the second rotation guide projection 32 and the second positioning guide projection 33. That is to say, the left edge of the second subject 100′ is contacted with the second rotation guide projection 32, and the right edge is contacted with the second positioning guide projection 33 for the purpose of the arrangement. If the subject 100′ is set to the initial position as mentioned above, the initial punching region A1 is placed at a position where it may be punched by the punching member 13. In this state, the push lever 10 is pressed to punch the subject by means of the punching member 13, thereby forming a first punching pattern P1′ (shown as a black area).

Subsequently, for the next punching, the second subject 100′ is rotated in a clockwise direction. At this time, the edge of the second subject 100′ is guided by the second rotation guide projections 31, 32. The subject 100′ is rotated to a position where the first punching pattern P1′ already formed is coincided with the second criterion marking 34 marked on the base 20, thereby coming to the state shown in FIGS. 9b and 10b. That is to say, the second criterion marking 34 sets a rotating angle of the second subject 100′, and in this state the second punching region A2 is positioned below the punching member 13.

If the second subject 100′ is punched in this state, the second punching pattern P2′ is formed in succession to the first punching pattern P1′.

In the same way, the second subject 100′ is rotated in a clockwise direction as much as a predetermined angle into a state shown in FIGS. 9c and 10c so that the second punching pattern P2′ is coincided with the criterion marking 34, and then it is punched to form a third punching pattern P3′.

Similarly to the above description, if the integer number of punching patterns are formed in a one-side (left) edge of the second subject 100′ based on its major axis X′ and then the other side (right) edge is punched in the same way, an oval pattern material as shown in FIG. 11 may be obtained.

In this embodiment, the guide projection is specifically illustrated, but it may be implemented in various ways within the scope of the invention, not limited thereto.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The punching device for edge decoration according to the present invention gives the following effects.

First, patterns may be successively formed along an edge of an oval subject to be punched.

Second, since an oval pattern material may be obtained by successively punching a specific pattern, it is possible to precisely punch an edge of an article requiring decoration such as a card, a letter, a photograph and various plate supports.

1. A punching device for punching an edge of an oval subject to make a pattern, comprising:
a jig having a pattern hole with a predetermined pattern;
a punching member having a punch pin corresponding to the pattern hole so as to form a punching pattern by punching an edge of one or more subjects supplied to the jig; and
a base on which the jig and the punching member are coupled, the base giving a base surface on which the subject to be punched is supplied,
wherein the base includes:
a rotation guide projection for guiding an edge of an oval subject while the oval subject is rotating, wherein a part of the rotation guide projection has a similar curvature to that of an edge of the oval subject;
a positioning guide projection for setting an initial position of the oval subject, so that an initial punching region of the oval subject is punched; and
a criterion marking having the same pattern as the pattern hole, or formed as a part of the pattern, so as to set a rotating angle of the oval subject so that the punching pattern is successively formed.

2. The punching device according to claim 1, wherein, based on a major axis of the oval subject, an edge at one side of the oval subject is contacted with at least a part of the rotation guide projection, and an edge at the other side of the oval subject is contacted with the positioning guide projection, thereby setting the initial position.

3. The punching device according to claim 1, wherein a number n of punching patterns are formed in any one-side edge of the oval subject on the basis of a major axis of the oval subject, wherein n is an integer value.

4. The punching device according to claim 1, wherein at least a part of the rotation guide projection protrudes from the base.

5. A punching device for respectively punching edges of a first oval subject and a second oval subject having different sizes to form a pattern, comprising:
a jig having a pattern hole with a predetermined pattern;
a punching member having a punch pin corresponding to the pattern hole so as to form a punching pattern by punching an edge of one or more subjects supplied to the jig; and
a base on which the jig and the punching member are coupled, the base giving a base surface on which the subject is supplied,
wherein the base includes:
a first rotation guide projection for guiding an edge of a first oval subject while the first oval subject is rotating, wherein a part of the rotation guide projection has a similar curvature to that of an edge of the first oval subject;
a first positioning guide projection for setting an initial position of the first oval subject, so that an initial punching region of the first oval subject is punched;
a first criterion marking having the same pattern as the pattern hole, or formed as a part of the pattern, so as to set a rotating angle of the first oval subject so that the punching pattern is successively formed;
a second rotation guide projection for guiding an edge of a second oval subject while the second oval subject is rotating, wherein a part of the rotation guide projection has a similar curvature to that of an edge of the second oval subject;
a second positioning guide projection for setting an initial position of the second oval subject, so that an initial punching region of the second oval subject is punched; and
a second criterion marking having the same pattern as the pattern hole, or formed as a part of the pattern, so as to set a rotating angle of the second oval subject so that the punching pattern is successively formed.

6. The punching device according to claim 5, wherein, based on a major axis of the first oval subject, an edge at one side of the first oval subject is contacted with at least a part of the first rotation guide projection, and an edge at the other side of the first oval subject is contacted with the first positioning guide projection, thereby setting the initial position of the first oval subject, and
wherein, based on a major axis of the second oval subject, an edge at one side of the second oval subject is contacted with at least a part of the second guide projection, and an edge at the other side of the second oval subject is contacted with the second positioning guide projection, thereby setting the initial position of the second oval subject.

7. The punching device according to claim 6, wherein the first positioning guide projection and the first criterion marking are respectively formed at an opposite side of the punching device to the second positioning guide projection and the second criterion marking, and wherein the first oval subject and the second oval subject are rotated in opposite directions during successive punching.

8. The punching device according to claim 5, wherein a number n of punching patterns are formed in any one-side edge of the first and second oval subjects on the basis of major axes of the first and second oval subjects, wherein n is an integer value.

9. The punching device according to claim 5, wherein at least a part of the rotation guide projection protrudes from the base.
